(19) United States
(12) Patent Application Publication
(10) Pub. No.: US 2026/0303768 A1
(43) Pub. Date: Oct. 1, 2026

(54) EXTENDED REALITY VIDEO PRODUCTION AND COMPOSITING SYSTEM

(71) Applicant: Famous Group Technologies Inc., Burbank, CA (US)

(72) Inventors: CJ Davis, Burbank, CA (US); Gregory Lawrence Harvey, Hermosa Beach, CA (US)

(21) Appl. No.: 19/093,746

(22) Filed: Mar. 28, 2025

(51) Int. Cl. H04N 13/117; G06T 3/12; G06T 7/80; G06V 10/25

(52) U.S. Cl. CPC H04N 13/117; G06T 3/12; G06T 7/80; G06V 10/25

(57) ABSTRACT

A method of simulating camera movements in a video production system having one or more fixed-position cameras is disclosed. One or more high-resolution video feeds are received from the one or more fixed-position cameras. Each of the one or more high-resolution video feeds is transformed into respective spherical projections based on respective lens distortion profiles and spatial reference data. One or more regions of interest are selected within the respective spherical projections. One or more movements of the one or more fixed-position cameras are simulated within the selected one or more regions of interest. An output video is generated that includes one of the one or more the regions of interest. The output video conforms to one or more broadcast resolution requirements.

### TECHNICAL FIELD

The present application generally relates to broadcast video production and extended reality integration systems, and, in one specific embodiment, to systems and methods for simulating camera movements and/or compositing virtual elements in live broadcasts using high-resolution cameras without requiring local physical camera operators.

### BACKGROUND

Live broadcast production has traditionally required extensive coordination between camera operators, directors, and production crews to capture and present content to viewers. Such productions typically involve multiple broadcast cameras with operators manually controlling pan, tilt, zoom, and other movements to track subjects and create dynamic shots. The setup and operation of these traditional broadcast systems often requires significant preparation time, rehearsals, and technical expertise.

Mixed reality elements have become increasingly common in live broadcasts, particularly for sporting events and other live entertainment. Conventional approaches for incorporating virtual content into live broadcasts rely on complex mechanical and optical tracking systems to align virtual elements with physical camera movements. These systems generally require specialized camera equipment, tracking hardware, and extensive calibration procedures that can disrupt venue operations.

The technical requirements and operational complexity of traditional broadcast systems with mixed reality capabilities create various challenges. Multiple skilled operators must coordinate their movements while monitoring virtual element positioning. Calibration procedures and rehearsals can require extended venue access. The real-time rendering quality of virtual elements may be constrained by processing limitations.

### BRIEF DESCRIPTION OF THE DRAWINGS

Some embodiments are illustrated by way of example and not limitation in the figures of the accompanying drawings.

FIG. 1 is a block diagram depicting an example architecture for a mixed reality video production system utilizing pre-rendered content and output conversion.

FIG. 2 is a block diagram depicting an example architecture for a mixed reality video production system incorporating real-time rendering capabilities and expanded monitoring functionality.

FIG. 3 is a block diagram illustrating an example method of calibrating cameras of a mixed reality video production system.

FIG. 4 is a block diagram illustrating an example method of simulating camera movements using fixed cameras of a mixed reality video production system.

FIG. 5 is a block diagram illustrating an example method of performing video compositing using fixed cameras of a mixed reality video production system.

FIG. 6 is a block diagram illustrating an example method of testing a mixed reality video production for inclusion in a live broadcast.

FIG. 7 is a block diagram illustrating a mobile device, according to an example embodiment.

FIG. 8 is a block diagram of machine in the example form of a computer system within which instructions for causing the machine to perform any one or more of the operations or methodologies discussed herein may be executed.

### DETAILED DESCRIPTION

In the following description, for purposes of explanation, numerous specific details are set forth to provide an understanding of various embodiments of the present subject matter. It will be evident, however, to those skilled in the art that various embodiments may be practiced without these specific details.

One technological problem of traditional video production systems is their reliance on complex camera tracking systems that require either optical or mechanical methods to synchronize physical camera movements with virtual content. Traditional optical tracking solutions use computer vision to identify reference points in the space, while mechanical tracking systems require specialized tripods with encoders to measure pan, tilt, and zoom movements. The disclosed system solves these tracking challenges by using a fixed-camera system that utilizes high-resolution video feeds (e.g., significantly higher than broadcast resolution, such as 8K or higher for 4K broadcast resolution) and implements a region of interest approach that simulates camera movements without any physical tracking hardware. In example embodiments, the system reprojects the camera image into a sphere to represent the point of view, eliminating parallax issues and ensuring proper perspective maintenance, particularly beneficial for long-lens camera work.

The selection of regions of interest may enable simulated camera movements by computationally selecting specific portions of the spherical projection to create the appearance of pan, tilt, and zoom effects. The system may processes the selected regions based on camera tracking data (e.g., in FBX file format) that defines field of view and/or rotation parameters to ensure accurate alignment between virtual and physical elements. In this way, the system may create smooth, natural-looking camera movements that simulate traditional camera operations while maintaining broadcast quality resolution in the output video.

The selection process may be precisely calculated based on desired camera movement parameters and may work within the spherical projection to ensure proper perspective maintenance. This may be particularly beneficial for long-lens camera work where maintaining spatial accuracy is critical.

In example embodiments, the system processes the camera tracking data to establish the desired camera movements. This tracking data can come from, for example, pre-rendered camera movements from 3D animation software, real-time controller input (e.g., Xbox controller), and/or pre-programmed show sequences.

The system may mathematically synchronize this tracking data with the selected regions of interest to maintain proper spatial relationships throughout the movements. This may involve processing the tracking data to establish precise field of view parameters, calculating rotation values that drive virtual camera positioning, and/or maintaining alignment between virtual and physical elements.

The selection calculations may account for the spherical reprojection of the camera image to eliminate parallax issues, proper perspective maintenance, particularly for long-lens camera work, clean edge definition around composited elements, and/or appropriate color space conversion and signal timing.

For zoom operations, the system may calculate regions based on the available resolution of the input feed (e.g., 8K), the target broadcast resolution (e.g., 4K or 1080p), and/or the desired zoom level while maintaining broadcast quality.

The calculations may create smooth transitions between different regions of interest to ensure natural-looking camera movements that simulate traditional pan, tilt, and zoom operations without requiring mechanical tracking systems.

The traditional mixed reality workflow demands extensive production resources and coordination that creates significant logistical barriers. Productions may require camera operators to rehearse specific movements, directors to coordinate multiple camera cuts, and extended venue access for setup and rehearsal time. These requirements often mean interrupting normal venue operations and coordinating multiple teams including broadcast personnel, camera operators, and directors. The disclosed system eliminates these logistical hurdles by, for example, utilizing compact fixed cameras (e.g., similar in size to security cameras), that can be pre-installed with minimal disruption. In example embodiments, the system enables pre-programmed camera movements and/or cuts that don't require live local operators, allowing mixed reality content to be triggered on demand without disrupting normal broadcast operations.

Another technical limitation of conventional systems is their reliance on real-time rendering engines, which constrains the visual quality possible in mixed reality productions. Traditional approaches are often limited by engine capabilities and/or available computing power for real-time rendering. In example embodiments, the disclosed system enables the use of pre-rendered content created through visual effects pipelines, allowing for significantly higher quality visuals than possible with real-time rendering. The system can work with pre-rendered content and/or real-time rendering engines, providing flexibility while maintaining synchronization between virtual and physical cameras.

The calibration requirements of traditional systems present another technical challenge, including with respect to lens distortion handling. Conventional systems must frequently recalibrate for zoom lens distortion that changes throughout the zoom range. In example embodiments, the disclosed system provides a streamlined calibration process using fixed focal length lenses that only require one-time calibration. For example, the system may utilize a multi-point calibration setup where users can identify known reference points in the camera feed to automatically solve for camera position and rotation in 3D space. This calibration process may include automated lens distortion calculations (e.g., using a ChArUco board or similar system that captures and analyzes a configurable number of still images (e.g., 50-60) to create a comprehensive lens profile).

Traditional mixed reality systems often require specialized technical expertise for operation, limiting their accessibility. The disclosed system addresses this problem by developing a simplified user interface and workflow that reduces technical complexity. In example embodiments, the system includes automated calibration processes, streamlined content synchronization, and/or intuitive show control interfaces that allow for easier operation by non-specialists. This technological solution enables mixed reality productions to be executed with minimal technical staff while maintaining high-quality results.

Traditional mixed reality systems face significant infrastructure limitations when it comes to remote production capabilities. Current systems may require extensive on-site equipment and personnel (e.g., due to their inability to transmit high-resolution video signals through standard remote production infrastructure). To the extent this technological problem may be reduced as network infrastructure evolves to support higher bandwidth signals, one or more aspects of the system disclosed herein may be configurable to enable operation in a remote production environment without requiring corresponding media server equipment to be on-site.

Another technological challenge involves the scalability and flexibility of mixed reality productions across different venues and events. Conventional systems require extensive reconfiguration and setup time for each new venue or production. In example embodiments, the disclosed system enables more efficient deployment, including through use of pre-configured venue photos or 3D scans, allowing shows to be built and tested before arriving on site. Once on location, the system may only require updating of the live video feed to replace the pre-production backplate, significantly reducing setup time and/or complexity.

Conventional systems often face limitations in content quality control and preview capabilities. For example, current approaches make it difficult to validate mixed reality content appearance before live deployment. The disclosed system solves this by enabling complete pre-visualization of shows using venue photos or 3D scans, allowing content to be fully tested and approved before installation. This solution provides greater creative control and reduces the risk of unexpected visual issues during live productions.

The disclosed system also addresses emerging technical challenges related to mobile deployment and cellular network integration. In example embodiments, the system may leverage advanced cellular networks and APIs (e.g., Verizon's QoD system) to enable high-resolution video streaming from mobile devices. Thus, in example embodiments, the system may enable applications of the technology using mobile phone cameras as video sources.

While some of the descriptions and examples provided herein may use one or more of “mixed reality,” “virtual reality,” or “augmented reality,” as examples, one skilled in the art would understand that the descriptions and examples are applicable to extended reality, including virtual reality, augmented reality, and/or mixed reality. In example embodiments, augmented reality (AR) includes a view of a the real (e.g., physical) world with an overlay of digital elements, mixed reality includes a view of the real world with an overlay of digital elements where physical and digital elements can interact, and virtual reality includes a fully-immersive digital environment.

A method of simulating camera movements in a video production system having one or more fixed-position cameras is disclosed. One or more high-resolution video feeds are received from the one or more fixed-position cameras. Each of the one or more high-resolution video feeds is transformed into respective spherical projections based on respective lens distortion profiles and spatial reference data. One or more regions of interest are selected within the respective spherical projections. One or more movements of the one or more fixed-position cameras are simulated within the selected one or more regions of interest. An output video is generated that includes one of the one or more the regions of interest. The output video conforms to one or more broadcast resolution requirements.

A method of implementing video compositing is disclosed. High-resolution live video feeds and rendered content are received (e.g., through specialized video transport infrastructure, where 12G signals are converted to fiber optic transmission and multiple high-resolution video signals are simultaneously processed through dedicated video I/O cards). The video feed is processed using lens distortion profiles that have been generated through analysis of calibration images. Spatial reference data (e.g., from Total Station measurements, Known Field Dimensions, or 3D Lidar scans) is incorporated to transform the video based on calculated camera position and rotation coordinates in 3D space. Camera tracking data (e.g., in FBX format) is synchronized with the rendered content to establish precise field of view and rotation parameters. 6-degrees-of-freedom positional information is processed to maintain proper scale, position, and/or orientation of virtual elements through real-time synchronization algorithms. Sophisticated compositing algorithms are then employed to perform high-quality operations, including complex lighting interactions, detailed texture processing, and/or advanced particle system integration, while maintaining clean edge definition (e.g., through alpha channel information that enables seamless blending between virtual elements and live background plates). The composited video is next conformed to broadcast standards through carefully orchestrated downsampling algorithms that maintain proper color space conversion and/or signal timing while preserving edge definition around composited elements during resolution conversion. The completed composited video signal is encoded with precise timing control through advanced buffering systems and output through either traditional broadcast video standards or network-based protocols for distribution.

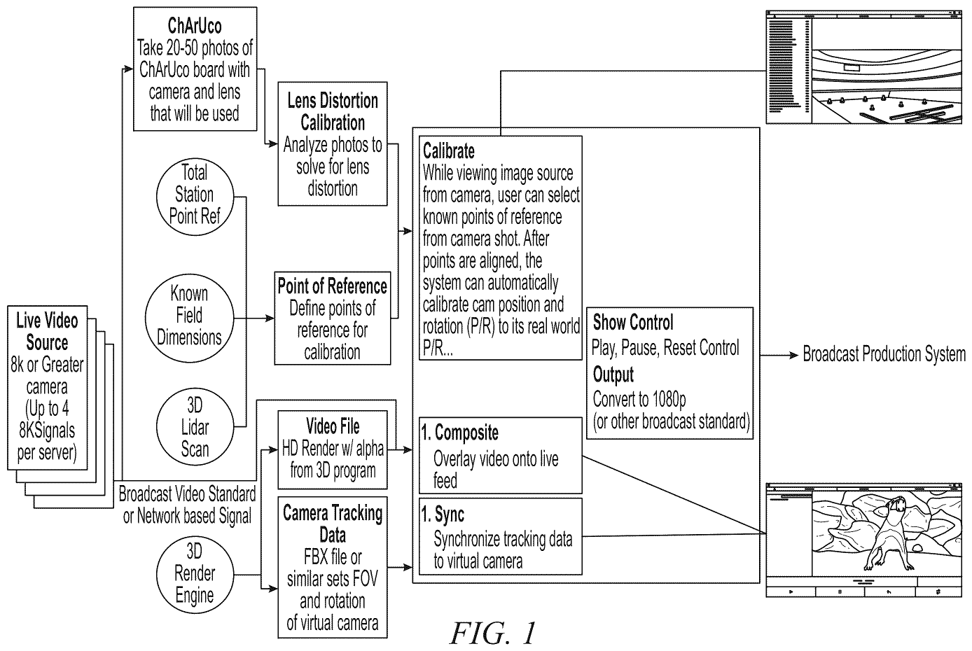

FIG. 1 is a block diagram depicting an example architecture for a mixed reality video production system utilizing pre-rendered content and output conversion.

In example embodiments, the Live Video Source consists of high resolution cameras (e.g., cameras with significantly higher resolution than the intended broadcast resolution, such as 8K cameras for 4K broadcast resolution). The use of high resolution may provide sufficient pixel density to enable zoom capabilities within a region of interest while maintaining broadcast quality resolution (e.g., 8K or greater resolution may enable up to 4x zoom capabilities for 4K broadcast resolution). This high-resolution approach also may enable the system to simulate camera movements without mechanical tracking systems. In example embodiments, the system may be configured to handle multiple high resolution signals per server.

This high-resolution video source may feed one or more destinations within the system, including a camera calibration module and a composite module.

In example embodiments, the camera calibration module receives input directly from the live video source. The camera calibration module may capture a series of calibration images using the production camera and lens. While FIG. 1 shows one specific implementation using a ChArUco board and 20-50 photos, the system could utilize other calibration patterns or methods to capture the necessary lens characteristics. In example embodiments, the camera calibration module is configured to capture sufficient calibration data to enable a Lens Distortion Calibration module to accurately calculate the lens distortion profile.

The output of this camera calibration module may feed into a Lens Distortion Calibration module.

In example embodiments, the Lens Distortion Calibration module receives input from the camera calibration module in the form of multiple calibration images captured using the production camera and lens.

The module may analyze these calibration images to mathematically solve for and calculate the lens distortion characteristics. This may create a comprehensive lens profile that, for fixed focal length lenses, only needs to be generated once, unlike traditional systems that require frequent recalibration for zoom lenses.

In example embodiments, the output of the Lens Distortion Calibration module feeds into the Calibrate function, where it is combined with point of reference data. This calibration data may enable the system to reproject the camera image into a sphere to represent the point of view, which eliminates parallax issues and ensures proper perspective maintenance. The lens distortion profile may help to ensure accurate alignment between physical and virtual elements when the system performs region of interest operations to simulate camera movements.

In example embodiments, the Lens Distortion Calibration module enables the system to maintain precise spatial relationships without requiring mechanical tracking hardware, as it provides the mathematical foundation for accurate reprojection of the camera image.

In example embodiments, the system includes one or multiple parallel calibration input methods. For example, the system may include calibration input methods for Total Station Point Ref, Known Field Dimensions, and/or 3D Lidar Scan.

In example embodiments, the Total Station Point Ref input method uses surveying equipment to precisely measure and establish reference points in the physical space. These measurements provide exact coordinate data that can be used for system calibration.

In example embodiments, the Known Field Dimensions input method uses pre-existing dimensional data about the venue or field. The system can use these known measurements as reference points for calibrating camera position and orientation.

In example embodiments, the 3D Lidar Scan input method uses laser-based scanning technology to create a detailed three-dimensional map of the venue space that can be used for calibration purposes.

One of or any combination of these input methods may feed into the Point of Reference module.

In example embodiments, the Point of Reference module receives the calibration input data to define reference points for system calibration. Once these points are aligned, the system automatically calibrates the camera position and rotation (P/R) to match its real-world coordinates.

The Calibrate function may combine inputs from one or more sources, including the Point of Reference module and the Lens Distortion Calibration module. In example embodiments, the Calibrate function processes these inputs (e.g., by allowing users to select known points of reference while viewing the image source from the camera). After these points are aligned with the defined reference data, the system may automatically calculate and/or calibrate the camera's position and/or rotation (P/R) relative to its real-world coordinates.

This calibration process may enable the system to reproject the camera image into a sphere to represent the point of view, which eliminates parallax issues and/or ensures proper perspective maintenance, particularly beneficial for long-lens camera work. In example embodiments, the combination of precise lens distortion data and spatial reference points allows the system to maintain accurate alignment between physical and virtual elements without requiring mechanical or optical tracking systems.

The calibrated output may provide the mathematical foundation for the system's region of interest operations, enabling accurate simulation of camera movements while maintaining proper perspective and spatial relationships.

The user interface showing the image of the football field may interface with the Calibrate function by allowing users to select known points of reference while viewing the live camera feed. When viewing this interface, users can identify and select specific reference points (such as corners of the field, top of logos, etc.) that correspond to the known spatial coordinates provided by the Total Station measurements, Known Field Dimensions, and/or 3D Lidar scans.

As these points are selected through the interface, the system uses them in conjunction with the lens distortion profile to automatically calculate and calibrate the camera's position and rotation (P/R) relative to its real-world coordinates. This multi-point calibration process enables the system to solve for where the camera is positioned in 3D space by correlating the selected visual reference points with their known physical coordinates.

The interface facilitates this calibration process by allowing users to zoom in for precise point selection, ensuring accurate alignment between the visual reference points and their corresponding spatial coordinates. Once sufficient points have been selected and aligned through the interface, the Calibrate function automatically solves for the camera's position and creates the mathematical foundation needed for accurate reprojection of the camera image into a sphere.

In example embodiments, a 3D Render Engine is configured to work with pre-rendered content and/or real-time rendering workflows. For pre-rendered content, it may enable the use of visual effects pipelines to create high-quality visuals that exceed what's possible with real-time rendering. When operating in real-time mode, it may process camera tracking data to maintain synchronization between virtual and physical cameras while still rendering content.

The 3D Render Engine may generate one or more outputs, including a video file and/or camera tracking data. In example embodiments, the video file includes HD rendered content with an alpha channel from a 3D program. This allows for pre-rendered content that can achieve higher visual quality than real-time rendering, as it is not constrained by game engine limitations or real-time processing capabilities. In example embodiments, the camera tracking data includes an FBX file or similar format that sets the field of view (FOV) and/or rotation parameters of the virtual camera. This data may enable synchronization between the virtual camera movements and the physical camera view.

In example embodiments, a composite function receives live video source and the video file as inputs. The composite function may overlay the video file onto the live feed, combining the pre-rendered or real-time rendered content with the actual camera footage. This compositing process may maintain proper alignment between virtual and physical elements (e.g., using the system's calibration data that enables accurate reprojection of the camera image into a sphere).

For pre-rendered content workflows, the composite function can work with high-quality visual effects that exceed what's possible with real-time rendering, because it is not constrained by game engine limitations. The system can also handle real-time rendered content while maintaining synchronization between virtual and physical cameras.

After compositing, the combined video signal may be sent to the Output module where it may be converted to 1080p or other broadcast standards before final output as either a broadcast video standard or network-based signal. In example embodiments, a network-based signal is an alternative output format to standard broadcast video standards. While broadcast video standards may represent a conventional television signal format, network-based signals may enable distribution through digital network infrastructure. The system can output the processed video in either format, providing flexibility for different distribution requirements and infrastructure limitations. In example embodiments, broadcast video standards may use traditional television broadcasting infrastructure, while network-based signals may utilize digital network protocols for transmission. Both signal types may require the system to conform the high-resolution video feed to appropriate resolution and format specifications to ensure compatibility with their respective distribution methods.

In example embodiments, a sync function receives camera tracking data (e.g., in the form of an FBX file or similar format) that sets the field of view (FOV) and/or rotation parameters of the virtual camera.

The sync function may synchronize this tracking data to the virtual camera to maintain proper alignment between the physical camera view and virtual elements. This synchronization may work in conjunction with the calibration data established by the calibrate function, which provides the mathematical foundation for accurate reprojection of the camera image into a sphere.

The sync function may operate alongside the Composite function, which may handle a different aspect of the mixed reality integration. For example, the sync function may manage camera positioning/movement synchronization while the composite function may handle the visual overlay of rendered content. The synchronized output may then feed into an Output module where it may be converted to 1080p or other broadcast standards before final output as a broadcast video standard and/or network-based signal.

The user interface depicting the exemplary panther content in FIG. 1 may interface with the composite and/or sync functions. In example embodiments, the composite function receives the pre-rendered or real-time rendered (e.g., panther) content through the video file (e.g., HD render with alpha channel) and overlays it onto the live video feed. This compositing process maintains proper alignment between the virtual (e.g., panther) content and the physical environment by utilizing the system's calibration data that enables accurate reprojection of the camera image.

In example embodiments, the sync function ensures the virtual camera movements showing the content (e.g., the panther) match the physical camera perspective by processing the camera tracking data (e.g., FBX file or similar format) that defines field of view and/or rotation parameters. This synchronization allows the content (e.g., the panther) to appear properly positioned and oriented within the physical space as camera movements occur.

Together, these functions enable high-quality mixed reality content like the panther to be displayed with proper perspective and positioning, whether using pre-rendered content that exceeds real-time rendering quality or real-time rendered content that allows for interactive adjustments. The interface allows operators to monitor and control this composited output (e.g., remotely, using a Show Control module).

In example embodiments, the Show Control module interfaces with the sync and/or composite functions (e.g., to enable coordinated playback of the synchronized camera movements and composited visual elements). In example embodiments, the Show Control module provides playback functionality for the mixed reality system, including Play, Pause, and/or Reset controls. This module may enable operators to control the timing and playback of both pre-rendered content and camera movements.

For pre-programmed shows, the Show Control module may allow operators to trigger mixed reality content on demand without requiring live local camera operators or directors. This enables the entire show, including camera movements and cuts, to be executed automatically through the Show Control interface.

The Show Control module may interfaces with both the Composite and Sync functions within the Broadcast Production System. Through this integration, it coordinates the synchronized playback of the composited overlay of rendered content onto the live feed and/or the synchronized camera tracking data that maintains alignment between virtual and physical cameras.

This simplified control interface may be part of the system's overall approach to reducing technical complexity and/or enabling operation by non-specialists. Rather than requiring multiple operators to coordinate camera movements and content playback, the Show Control module allows a single operator to execute complex mixed reality sequences through basic playback controls.

In example embodiments, the Output module is configured to convert the composited and synchronized mixed reality content to broadcast-standard formats. The module may receive the processed video signal after it has passed through both the Composite and Sync functions. It then converts this high-resolution input down to 1080p or other broadcast standards as required for final distribution.

The Output module can generate broadcast video standard signals and/or network-based signals. This conversion capability may ensure compatibility with existing broadcast infrastructure while still maintaining the benefits of the high-resolution capture system. The system's ability to work with both traditional broadcast standards and network-based signals provides flexibility for different distribution requirements and infrastructure limitations.

In example embodiments, the Output module represents a final stage in the signal chain before the content is distributed to broadcast or streaming platforms, ensuring that the mixed reality content meets industry standard specifications while preserving the quality and precision of the virtual element compositing.

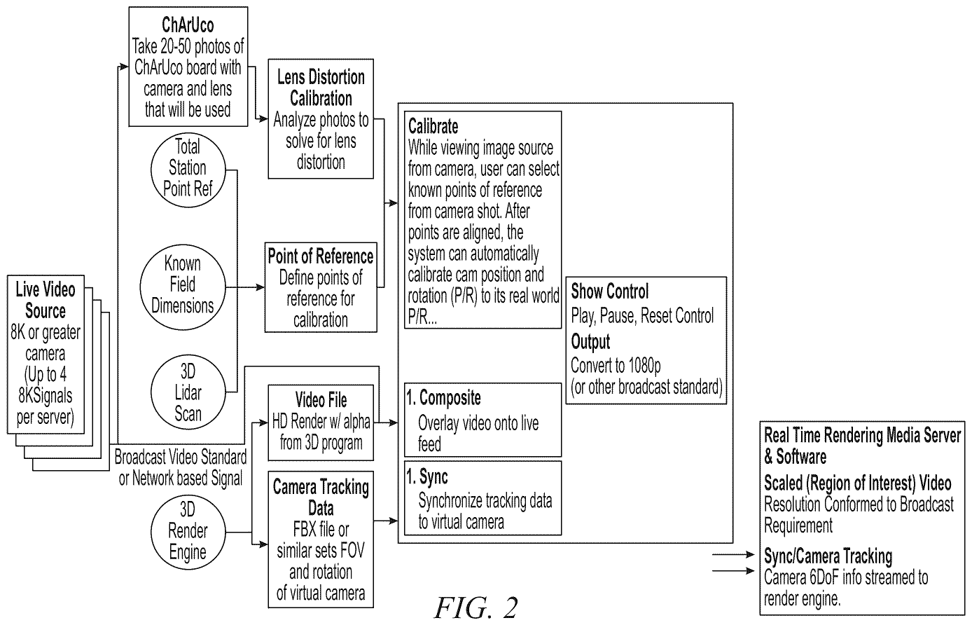

FIG. 2 is a block diagram depicting an example architecture for a mixed reality video production system incorporating real-time rendering capabilities and expanded monitoring functionality. FIG. 2 includes the same input methods, calibration processes, and compositing/synchronization functions illustrated in FIG. 1, but also includes components related to real-time rendering, scaled video, and/or sync/camera tracking.

In example embodiments, the Real-time Rendering Media Server & Software component is configured to serve as a specialized processing system that handles one or more aspects of the mixed reality video pipeline. For example, it may receive the calibrated camera feed and process it through one or more stages, such as performing Scaled Region of Interest video processing, conforming the resolution to broadcast requirements, and/or handling Sync/Camera Tracking (e.g., where camera 6DoF (degrees of freedom) information is streamed to a render engine).

This real-time processing capability may enable the system to maintain synchronization between virtual and physical cameras while rendering content in real-time, as opposed to working with pre-rendered content. The media server may interface with the composite function for overlaying video onto the live feed and/or the sync function for maintaining proper camera tracking alignment. It may be configured to work in conjunction with the Show Control module to enable coordinated playback of synchronized camera movements and/or composited visual elements, while ultimately feeding into the Output stage where the signal is converted to broadcast standards.

This real-time rendering approach, while potentially limited in visual quality compared to pre-rendered content due to game engine and processing power constraints, provides the flexibility needed for interactive adjustments and live production environments.

In example embodiments, the Scaled (Region of Interest) Video component is configured to process the high-resolution camera feed to enable simulated camera movements without requiring physical tracking hardware. This component may take the calibrated camera feed and performs region of interest operations that allow the system to simulate pan, tilt, and/or zoom movements by selecting and processing specific portions of the high-resolution input.

In example embodiments, the scaling process maintains proper perspective and spatial relationships by utilizing the calibration data that enables accurate reprojection of the camera image into a sphere. This spherical reprojection may be helpful for eliminating parallax issues and ensuring proper perspective maintenance, especially beneficial for long-lens camera work.

The scaled video component may work within the Real-time Rendering Media Server & Software to process the video before it is conformed to broadcast resolution requirements. The system can achieve zoom capabilities within the region of interest while maintaining broadcast quality resolution.

After the scaling process, the video feed may continue through the signal chain where it is synchronized with camera tracking data (6DoF information streamed to the render engine) and ultimately conformed to broadcast resolution requirements.

In example embodiments, the Sync/Camera Tracking module is configured to process camera 6DoF (degrees of freedom) information and stream it to a render engine. This module may receive Camera Tracking Data in the form of an FBX file or similar format that defines the field of view and rotation parameters of the virtual camera.

The module may work in conjunction with the Real-time Rendering Media Server & Software to maintain proper synchronization between the physical camera view and virtual elements. After the video signal has been processed through the Scaled Region of Interest stage and had its resolution conformed to broadcast requirements, the Sync/Camera Tracking module may ensure accurate alignment between the virtual and physical camera perspectives.

This synchronization process may rely on the calibration data established during system setup, which provides the mathematical foundation for accurate reprojection of the camera image into a sphere. The module may enable the system to maintain precise spatial relationships without requiring mechanical tracking hardware, as it processes the virtual camera positioning data in real-time to match the region of interest operations being performed on the high-resolution video feed.

In example embodiments, the Sync/Camera Tracking module interfaces with the Show Control system (e.g., Play, Pause, Reset controls) to enable coordinated playback of synchronized camera movements while maintaining proper alignment between virtual and physical elements throughout the production.

In example embodiments, the hardware underlying the example architectures of FIG. 1 and FIG. 2 may include several interconnected components. The camera system may consists of fixed-position high resolution cameras, approximately the size of industrial security cameras, equipped with fixed focal length lenses. These cameras may connect to signal converters (e.g., using 12G infrastructure), which may then be converted to fiber for transmission throughout the venue in which the system is deployed.

The signal transmission infrastructure may include video transport hardware (e.g., supporting 12G signals), fiber optic cabling for venue-wide transmission, and/or signal conversion equipment for input and/or output stages. The media server infrastructure may comprises one or more servers, each capable of processing up to multiple (e.g., four) high resolution video signals simultaneously and containing multiple (e.g., four) video I/O cards specifically for consuming these high resolution signals.

For system calibration, the hardware may include a calibration pattern board, Total Station surveying equipment, and/or 3D Lidar scanning equipment for establishing spatial reference points. This calibration hardware may interface with the media server system to enable accurate camera positioning and/or lens distortion calculations.

The broadcast output chain may include signal conversion hardware for converting the processed video to broadcast standards (such as 1080p) and routing equipment for distributing broadcast video standard and/or network-based signal outputs. Additional hardware may include a dedicated real-time rendering media server, monitoring systems, and/or supplemental processing hardware (e.g., for handling scaled regions of interest video and/or real-time camera tracking data streaming).

The system may include rack-mounted equipment for housing the media servers, signal converters, and/or video I/O infrastructure. Components of the system may be interconnected through a combination of (e.g., 12G) video cables, fiber optic infrastructure, and/or standard broadcast signal routing equipment, creating a comprehensive mixed reality production system capable of handling multiple high-resolution video streams while maintaining precise synchronization between virtual and physical elements.

In example embodiments, one or more components of the system may be implemented as cloud-based services, assuming sufficient network infrastructure for supporting the transmission of high-resolution video signals while maintaining low-latency processing to ensure proper synchronization between virtual and physical elements, particularly for live production.

For example, the Real-time Rendering Media Server & Software component may be hosted in a remote facility, eliminating the need for on-premise media server equipment, once infrastructure evolves to support high-bandwidth video signal transmission. This cloud migration would enable remote production capabilities while maintaining the core functionality of the system.

The video processing and compositing functions may be performed in cloud-based infrastructure, with only the cameras and basic signal conversion equipment remaining on-premise. The system could leverage advanced network APIs (like Verizon's QoD) to enable high-resolution video streaming to cloud processing systems.

The calibration and point-of-reference calculations may be performed in cloud-based computing resources, with only the initial image capture and reference point collection occurring on-premise. This would reduce the amount of local computing hardware required while maintaining the system's ability to accurately calculate camera positions and lens distortion profiles.

The Show Control functionality may be implemented through cloud-based interfaces, allowing remote operation of the mixed reality system while maintaining synchronization between virtual and physical elements. This would enable productions to be controlled from any location with sufficient network connectivity.

In example embodiments, the system provides technological advantages in terms of deployment efficiency and performance improvements over conventional systems:

In example embodiments, the system eliminates the need for complex mechanical or optical tracking hardware, instead using fixed cameras similar in size to security cameras that can be pre-installed with minimal disruption. Unlike traditional systems that require extensive venue access for setup and rehearsal time, this system can be deployed more quickly (e.g., in as little as a day in advance) without interrupting normal venue operations.

In example embodiments, the system enables higher quality visual output by allowing the use of pre-rendered content created through traditional visual effects pipelines, exceeding the quality limitations of real-time game engines used in conventional systems. The fixed camera approach with lens distortion calibration only needs to be performed once, unlike traditional systems that require frequent recalibration for zoom lenses. The system may also maintains precise spatial relationships through spherical reprojection, eliminating parallax issues particularly beneficial for long-lens camera work.

In example embodiments, the system also reduces costs by eliminating the need for multiple specialized personnel, including camera operators, directors, and technical staff typically required for traditional mixed reality productions. For multi-event deployments or permanent installations, the hardware costs are quickly amortized since the system doesn't require full-time technicians for operation, unlike conventional systems that need up to two full-time specialists with niche knowledge.

Additionally, the system provides better creative control through complete pre-visualization capabilities, allowing content to be fully tested and approved before installation, reducing the risk of unexpected visual issues during live productions.

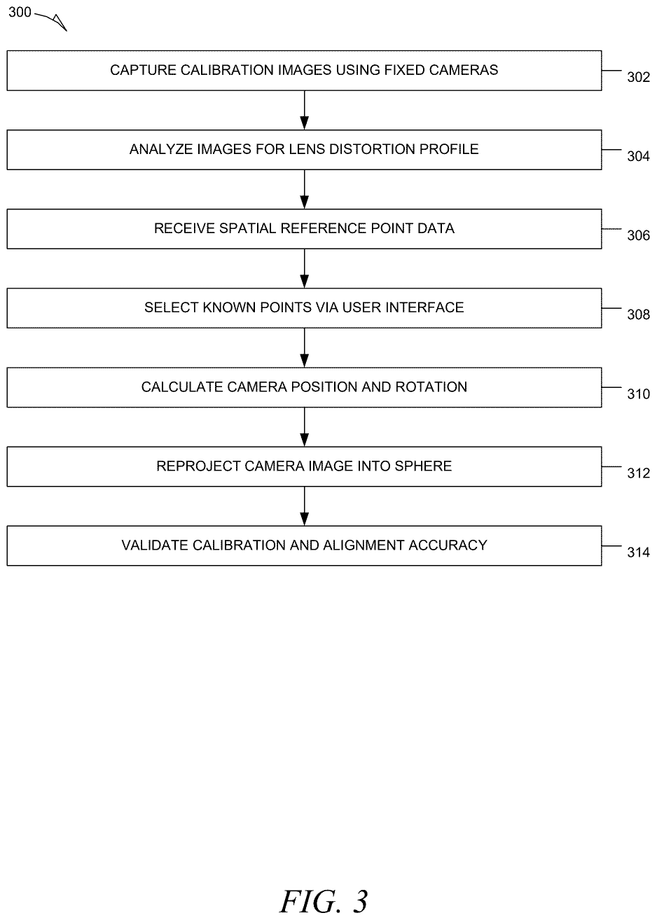

FIG. 3 is a block diagram illustrating an example method of calibrating cameras of a mixed reality video production system.

At operation 302, a series of calibration images are captured using the specific production camera and fixed focal length lens combination that will be employed during the broadcast. In example embodiments, these images are taken of a calibration pattern board. In example embodiments, a predetermined or configurable number of calibration images (e.g., 20-50) are captured.

At operation 304, the captured calibration images are computationally analyzed to mathematically determine the lens distortion characteristics of the camera and/or lens combination. From this analysis, a comprehensive lens profile is generated. In example embodiments, this lens profile will only need to be created once for fixed focal length lenses, unlike traditional systems requiring frequent recalibration of zoom lenses.

In example embodiments, the captured calibration images are processed through automated lens distortion calculations that analyze calibration patterns to create a comprehensive lens profile. In example embodiments, the system reads each calibration image individually, identifies the locations of reference points within each image, and performs this analysis across the full set of calibration images. For example, when using a ChArUco board calibration pattern, the system may identify the locations of QR codes on the board within each image. This multi-image analysis may enable the system to solve for the complete lens distortion characteristics and generate a lens profile.

The mathematical analysis may enable the system to reproject the camera image into a sphere to represent the point of view, which may be helpful for eliminating parallax issues and/or ensuring proper perspective maintenance throughout any simulated camera movements.

At operation 306, spatial reference data is received into the system through one or more input methods. The one or more input methods may include Total Station Point Ref measurements for precise coordinate data, Known Field Dimensions providing pre-existing dimensional information about the venue, and/or 3D Lidar scan data, creating a detailed three-dimensional map of the space.

At operation 308, points of reference are defined (e.g., through a user interface) where known points are selected while viewing the image source from the camera. The interface enables users to zoom in for precise point selection, ensuring accurate alignment between the visual reference points and their corresponding spatial coordinates.

At operation 310, the camera's position and rotation (P/R) relative to real-world coordinates are automatically calculated by the system based on the aligned reference points. This calculation creates the mathematical foundation needed for accurate reprojection of the camera image.

In example embodiments, the system uses a multipoint calibration setup where at least three reference points with known coordinates are identified in the camera feed. Once these points are tapped or selected, the system may mathematically solve for where the camera is positioned in 3D space (e.g., by correlating the selected visual reference points with their corresponding physical coordinates).

This calculation process may enable the system to determine both the exact position of the camera in physical space as well as its rotational orientation. The solved camera position and rotation values provide the mathematical foundation needed for accurate reprojection of the camera image into a sphere, which may be helpful for eliminating parallax issues and/or ensuring proper perspective maintenance throughout any simulated camera movements.

The automatic calculation may particularly benefit long-lens camera configurations, as the precise determination of position and rotation enables accurate spatial relationships to be maintained when performing region of interest operations to simulate camera movements.

At operation 312, the camera image is reprojected into a spherical representation (e.g., through a mathematical process that combines the lens distortion profile and spatial calibration data). This spherical reprojection may be helpful for representing the camera's point of view in a way that eliminates parallax issues that would otherwise occur during camera movement simulation.

In example embodiments, the reprojection process takes the original calibrated position of the camera and reprojects the image that it sees based on the calculated lens distortion profile and/or spatial reference points. For example, if the camera is inherently pointed downward, the system will reproject that view into the appropriate part of the sphere, ensuring that as virtual movements are simulated within that sphere, the proper perspective is maintained.

This spherical reprojection may be particularly useful for long-lens camera work, as it ensures that when moving off to the left or top corners, the distortion doesn't become significantly worse, which could make the footage unusable for mixed reality applications where virtual elements need to accurately overlay the physical world. The reprojection process may create a comprehensive spherical view that maintains consistent perspective and spatial relationships throughout any simulated camera movements.

The reprojected spherical image may serve as a foundation for subsequent region of interest operations, enabling the system to simulate camera movements while maintaining proper perspective and/or eliminating distortion that would otherwise occur at the corners or edges of the frame.

At operation 314, calibration accuracy is validated by the system through confirmation of proper alignment between physical reference points and virtual elements. This validation ensures the system is properly calibrated and ready for mixed reality production without requiring further calibration during the broadcast.

In example embodiments, calibration accuracy is validated through a process that confirms proper alignment between physical reference points and virtual elements. The system may use the calculated lens distortion profile and/or spatial calibration data to verify that the spherical reprojection accurately maintains proper perspective and/or eliminates parallax issues. This validation ensures that the mathematical foundation established during calibration will enable accurate simulation of camera movements while maintaining precise spatial relationships between physical and virtual elements. Once validated, this calibration data may enable the system to maintain proper alignment throughout any simulated camera movements without requiring recalibration during the broadcast.

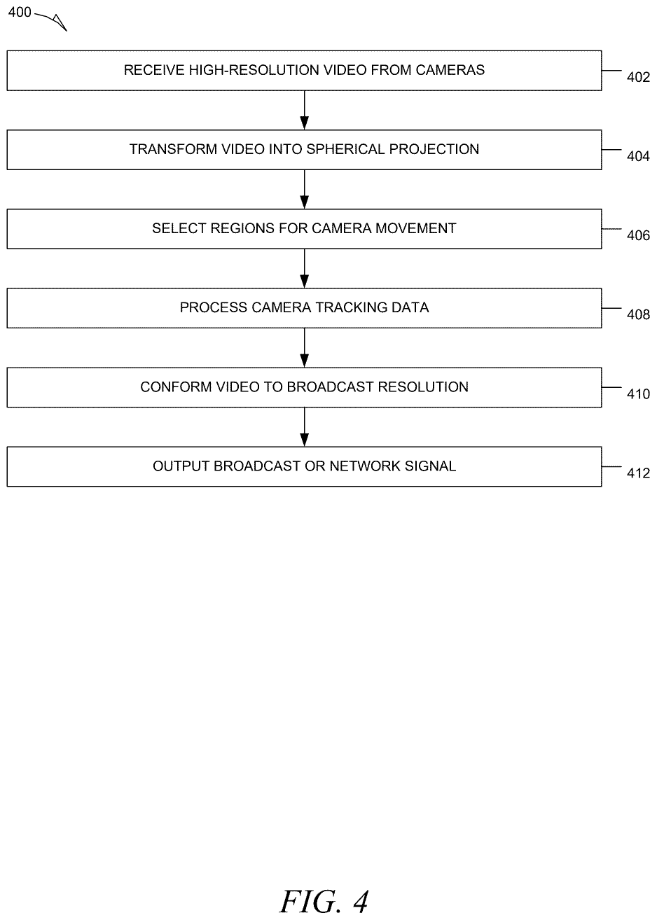

FIG. 4 is a block diagram illustrating an example method of simulating camera movements using fixed cameras of a mixed reality video production system.

At operation 402, a high-resolution video feed is received from the fixed-position camera into the system (e.g., through specialized video transport infrastructure). In example embodiments, the high resolution video feed has a significantly higher resolution than the target broadcast resolution. For example, the high resolution video feed may have 8K resolution for an intended target broadcast resolution of 4K or 1080p. In example embodiments, this feed may be initially transmitted via 12G signals, which may then be converted to fiber optic cabling for efficient wide transmission within a venue. The high-resolution capture may be important for enabling the system's ability to simulate camera movements without mechanical tracking hardware.

At operation 404, the system applies one or more mathematical transformations to the incoming video feed using previously generated lens distortion profile and/or spatial reference data (see, e.g., FIG. 3). This transformation process may reproject the entire camera image into a spherical projection, creating a comprehensive representation of the camera's viewpoint. The spherical reprojection may eliminate parallax issues that would otherwise occur during camera movement simulation and/or may help ensure that proper perspective is maintained throughout the virtual camera movements.

At operation 406, sophisticated computational algorithms are employed to select and process specific regions of interest within the spherical projection. These selections may be precisely calculated based on desired camera movement parameters that would traditionally require physical camera operations. In example embodiments, the system leverages the high-resolution input to enable up to zoom capabilities while maintaining broadcast quality resolution. Any zoom limitation may be based on the available resolution in the camera technology in comparison to the target broadcast resolution. The region of interest selection process may create smooth, natural-looking camera movements that simulate traditional pan, tilt, and/or zoom operations.

At operation 408, detailed camera tracking data (e.g., provided in FBX file format or similar) is processed through the system's synchronization engine. This processing may establish precise field of view and/or rotation parameters that would typically be generated by mechanical tracking systems. The tracking data may be mathematically synchronized with the selected region of interest using the spatial relationships established during the calibration process, ensuring that all simulated camera movements maintain proper perspective and spatial accuracy.

At operation 410, advanced signal processing is applied to conform the region of interest video to meet broadcast standards. During this process, the high-resolution input may be carefully downsampled to 1080p or other required broadcast resolutions. In example embodiments, the processing algorithms ensure that the quality and/or precision of the simulated camera movements are preserved throughout the resolution conversion process, maintaining the natural look and feel of traditional camera operations.

At operation 412, the final processed video signal is output through traditional broadcast video standards and/or network-based signal protocols. The system's flexible output capabilities may enable compatibility with various distribution infrastructures while maintaining the precise timing and/or synchronization required for broadcast applications. This flexibility allows the system to integrate seamlessly with existing broadcast workflows while providing the enhanced capabilities of virtual camera movement simulation.

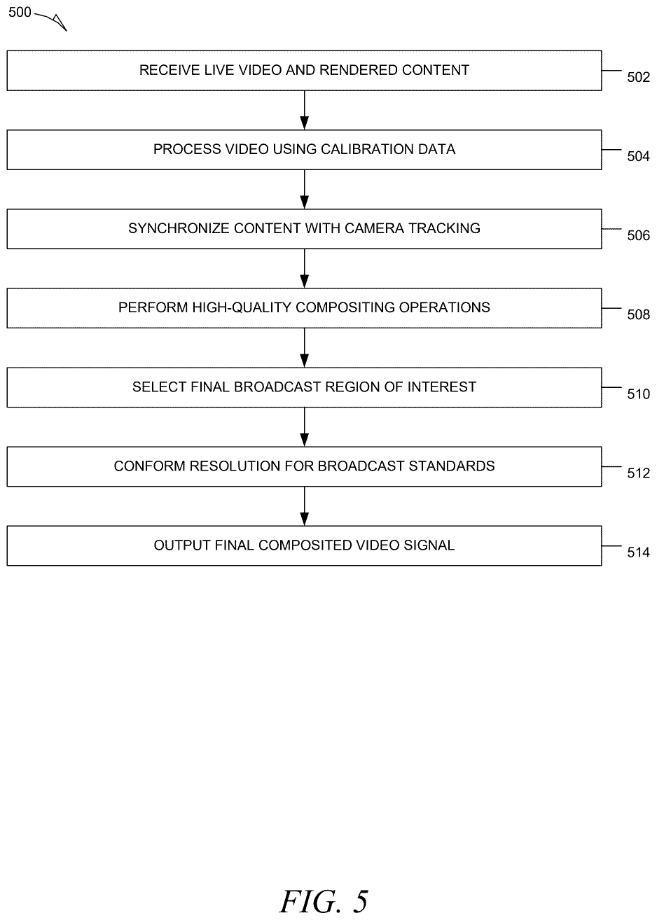

FIG. 5 is a block diagram illustrating an example method of performing video compositing using fixed cameras of a mixed reality video production system.

At operation 502, multiple high-bandwidth video signals are simultaneously ingested and processed (e.g., through specialized hardware interfaces). The live video feed, captured at high resolution, may be received through dedicated (e.g., 12G) infrastructure that is converted to fiber optic transmission systems for venue-wide distribution. The signal path may incorporate specialized video I/O cards capable of consuming multiple high resolution signals simultaneously. Concurrently, rendered content (e.g., with alpha channel information) is received as pre-rendered HD files (e.g., from visual effects pipelines) and/or as real-time rendered output (e.g., from 3D programs) through the media server infrastructure.

At operation 504, a complex series of mathematical transformations is applied to the live video feed using multi-point calibration data. The lens distortion profile, which may be generated through analysis of a set of calibration images, may be computationally applied to correct for optical aberrations. The spatial reference information, which may be derived from one or more of Total Station measurements, Known Field Dimensions, and/or 3D Lidar scans, may enable precise geometric transformations that maintain proper perspective throughout any simulated camera movements. This processed feed may be digitally prepared as the foundational background plate, with the spherical reprojection process ensuring elimination of parallax issues while preserving color fidelity and/or spatial accuracy throughout the signal chain.

At operation 506, real-time synchronization algorithms process the camera tracking data to align rendered content with the physical space. A file such as an FBX file or a file with a similar format may contain comprehensive 6-degrees-of-freedom positional information that may be mathematically processed to ensure virtual elements maintain proper scale, position, and/or orientation relative to the calibrated camera position. This synchronization process may account for region-of-interest-based simulated camera movements and/or any predetermined animation of virtual elements. In example embodiments, the tracking data may be continuously updated to maintain precise spatial relationships.

At operation 508, advanced compositing algorithms perform real-time overlay operations (e.g., by combining the high-resolution live video feed with rendered content). The system may leverage sophisticated visual effects techniques that exceed real-time rendering limitations when working with pre-rendered content, enabling complex lighting interactions, detailed textures, and/or advanced particle systems. The compositing process may maintain proper perspective throughout any simulated camera movements by utilizing the spherical reprojection of the camera image, ensuring virtual elements appear correctly positioned and oriented within the physical space. This compositing capability allows the system to seamlessly integrate both pre-rendered content that exceeds game engine quality limitations and real-time rendered content that enables interactive adjustments, providing flexibility for different production requirements while maintaining precise spatial relationships between virtual and physical elements.

In example embodiments, the system may perform real-time overlay operations that combine the high-resolution live video feed with rendered content containing alpha channel information. The alpha channel may enable seamless blending between the virtual elements and the live background plate.

For pre-rendered content, the compositing algorithms may leverage sophisticated visual effects techniques including complex lighting interactions, detailed texture processing, and/or advanced particle system integration.

The compositing process may maintains proper perspective by utilizing the spherical reprojection of the camera image, which ensures virtual elements appear correctly positioned and oriented within the physical space as camera movements occur. This involves mathematical transformations that account for the lens distortion profile and spatial calibration data to maintain accurate spatial relationships throughout any simulated camera movements.

The compositing algorithms may also handle proper edge definition around composited elements while ensuring appropriate color space conversion and signal timing as the content is processed for broadcast output. This may include maintaining clean edges during the resolution conforming process when converting from high-resolution inputs to broadcast standard formats.

At operation 510, a final region of interest is computationally selected from the spherical projection to define the precise portion of the composited video that will be presented in the broadcast output. This selection process may be performed through sophisticated algorithms that analyze the camera tracking data, virtual element positioning, and/or compositional requirements to determine the optimal framing for broadcast presentation. The selected region may undergo precise mathematical transformations to maintain proper perspective relationships while ensuring the most visually compelling portion of the scene is featured. One or more parameters may be evaluated during this selection, including subject positioning, compositional balance, and/or narrative focus, with the system capable of dynamically adjusting the region based on pre-programmed show control parameters or real-time input. The selection algorithms may incorporate advanced edge detection and/or content awareness capabilities to ensure virtual elements remain properly framed and visible throughout the broadcast output. This operation may serve as a bridge between the high-quality compositing operations and the resolution conforming process, ensuring that the final broadcast output maintains optimal visual impact while preserving the spatial accuracy established through the system's calibration and synchronization processes.

At operation 512, advanced signal processing algorithms are applied to conform the composited video to broadcast standards. In example embodiments, the high-resolution composited feed undergoes carefully orchestrated downsampling to 1080p or other required broadcast formats, employing sophisticated algorithms to preserve the quality of both the live video and virtual elements. This process maintains clean edge definition around composited elements while ensuring proper color space conversion, signal timing, and/or broadcast compliance. The resolution conforming process is designed to maintain the system's ability to simulate up to zoom capabilities and simulated movement capabilities while preserving broadcast quality resolution.

At operation 514, the final composited signal is encoded and output through industry-standard interfaces with precise timing control. The system's flexible output architecture may support traditional broadcast video standards and/or network-based protocols, incorporating advanced buffering and/or timing systems to ensure frame-accurate delivery. The output stage maintains precise synchronization between virtual and physical elements throughout the entire signal chain while providing compatibility with existing broadcast infrastructure through standard broadcast video outputs and/or network-based signal distribution.

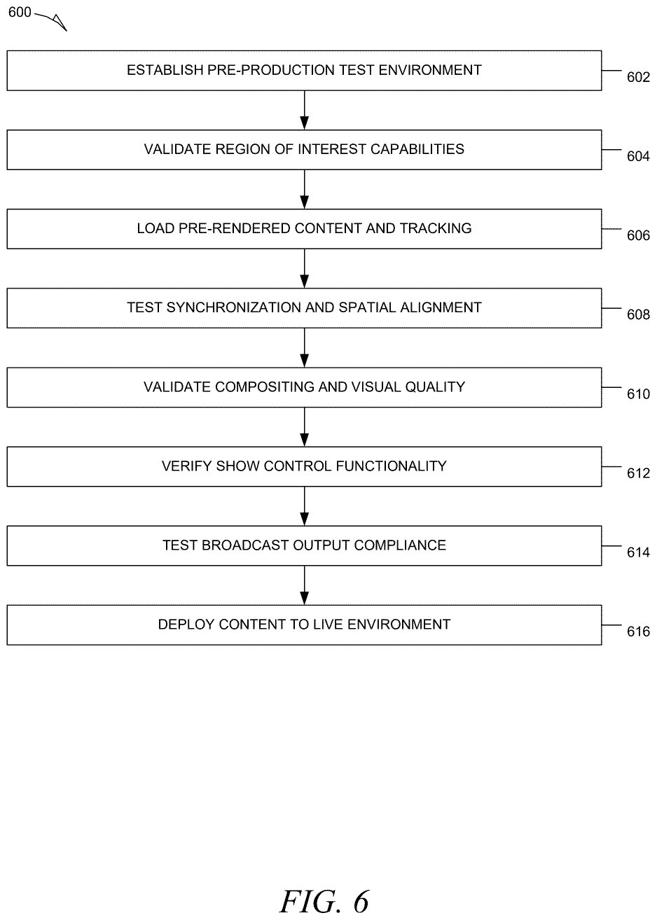

FIG. 6 is a block diagram illustrating an example method of testing a mixed video production for inclusion in a live broadcast.

At operation 602, a comprehensive pre-production test environment is established (e.g., through sophisticated data ingestion processes). Venue photos or 3D Lidar scan data may be loaded into the system's media server infrastructure and processed to create an accurate digital representation of the physical space. This digital environment may enable complete pre-visualization of shows through the system's calibration and compositing pipelines, allowing for detailed content validation before physical deployment.

At operation 604, extensive testing of the region of interest functionality is performed using the venue imagery. The system's ability to maintain proper perspective through spherical reprojection may be validated across multiple zoom levels. In example embodiments, particular attention may be paid to the zoom threshold where pixel-level resolution must be preserved for broadcast quality. The testing may include validation of smooth transitions between different regions of interest to ensure natural-looking camera movements without mechanical tracking systems.

At operation 606, pre-rendered content may be processed through the system's media server infrastructure. The high-quality visual elements, created through visual effects pipelines without real-time rendering constraints, may be loaded alongside precise camera tracking data (e.g., in FBX format). The tracking data may undergo detailed processing to establish exact field of view parameters and/or rotation values that will drive virtual camera positioning throughout the production sequence.

At operation 608, advanced synchronization testing is executed using the system's calibration framework. The spatial relationships between virtual and physical elements may be validated through comprehensive testing of all planned camera movements, ensuring proper maintenance of perspective and elimination of parallax issues throughout the entire production sequence.

At operation 610, the compositing engine undergoes thorough testing using the pre-rendered content and venue imagery. The system's ability to maintain proper edge definition, color fidelity, and/or spatial relationships may be validated across various lighting conditions and/or camera positions. This testing may ensure that high-quality visual effects are seamlessly integrated with the background plate while maintaining broadcast-standard quality.

At operation 612, complete show sequence validation is performed through the Show Control interface. The system's playback controls may be tested for frame-accurate execution of all camera movements and virtual element animations. The automation capabilities may be verified to ensure proper execution without requiring live local camera operators or directors. In example embodiments, particular attention may be paid to synchronization between virtual and physical elements.

At operation 614, broadcast standard compliance testing is performed on the final output. The system's resolution conforming processes may be validated to ensure proper conversion from high-resolution inputs to broadcast formats while maintaining quality across simulated camera movements and virtual elements. Signal timing and/or color space conversion accuracy may be verified to meet broadcast specifications.

At operation 616, the validated content is deployed to the live production environment. The pre-production background plate may be replaced with the live high-resolution camera feed while maintaining all calibrated spatial relationships and synchronized camera movements. In example embodiments, the system's infrastructure (e.g., network and video I/O cards) may be configured to handle the live high-resolution signals, enabling seamless transition from test environment to live production while preserving all pre-validated camera movements and virtual element positioning.

Consider a panther animation that appears during a live broadcast of a football game (e.g., during a half time show).

The system undergoes calibration per FIG. 3, where calibration images are captured using the fixed high-resolution camera positioned at the stadium, the lens distortion profile is calculated, and spatial reference points around the football field are defined to establish accurate camera positioning.

Following FIG. 6's pre-production workflow, the panther animation is pre-rendered through visual effects pipelines to achieve higher quality than possible with real-time game engines. This content may be tested using venue photos or 3D scans as the background plate, with the system validating all planned camera movements showing the panther jumping onto the field and running up to the scoreboard.

During live production, FIG. 4's camera simulation processes are engaged, where the high-resolution camera feed is reprojected into a sphere to enable simulated camera movements without physical tracking hardware. The region of interest selection creates the appearance of camera movements following the panther as it moves across the field.

Simultaneously, FIG. 5's compositing operations are performed, where the pre-rendered panther animation (e.g., with alpha channel) is precisely synchronized with the camera tracking data to maintain proper positioning relative to the field. The compositing algorithms ensure seamless integration of the high-quality panther animation with the live video feed while maintaining proper perspective throughout the simulated camera movements.

The final composited output showing the panther interacting with the field and scoreboard is converted to broadcast standard resolution and distributed through either traditional broadcast or network-based protocols. The entire sequence is triggered through the Show Control interface without requiring live camera local operators or directors.

Consider a giant Coca-Cola can animation that spills Coca-Cola over a playing field and creates bubbling effects.

The system's calibration process would be performed per FIG. 3, where the fixed high-resolution camera is calibrated at the stadium using the lens distortion profile and spatial reference points are defined around the football field to establish precise positioning for the virtual Coca-Cola elements.

Following FIG. 6's pre-production workflow, the Coca-Cola can and liquid animation would be pre-rendered through visual effects pipelines to achieve higher quality than possible with real-time game engines, particularly important for realistic liquid simulation and bubbling effects. This content would be tested using venue photos or 3D scans as the background plate, with the system validating all planned camera movements showing the can spilling and the liquid interacting with the field.

During live production, FIG. 4's camera simulation processes would be engaged, where the high-resolution camera feed is reprojected into a sphere to enable simulated camera movements without physical tracking hardware. The region of interest selection would create the appearance of camera movements following the Coca-Cola can and liquid as they move across the field.

Simultaneously, FIG. 5's compositing operations would be performed, where the pre-rendered Coca-Cola animation with alpha channel is precisely synchronized with the camera tracking data to maintain proper positioning relative to the field. The compositing algorithms would ensure seamless integration of the high-quality liquid animation and bubbling effects with the live video feed while maintaining proper perspective throughout the simulated camera movements.

The final composited output showing the Coca-Cola can and liquid interacting with the field would be converted to broadcast standard resolution and distributed through either traditional broadcast or network-based protocols. The entire sequence would be triggered through the Show Control interface without requiring live local camera operators or directors.

Consider a giant transformer appearing in a venue as part of a mixed reality show.

The system's calibration process would be performed per FIG. 3, where the fixed 8K camera is calibrated at the concert venue using the lens distortion profile and spatial reference points are defined around the stage and seating areas to establish precise positioning for the giant transformer character.

Following FIG. 6's pre-production workflow, the transformer animation would be pre-rendered through traditional visual effects pipelines to achieve higher quality than possible with real-time game engines, particularly important for complex mechanical transformations and detailed textures of the robot character interacting with the stage environment. This content would be tested using venue photos or 3D scans as the background plate, with the system validating all planned camera movements showing the transformer appearing and interacting with the stage, lighting rigs, and other venue structures.

During live production, FIG. 4's camera simulation processes would be engaged, where the high-resolution camera feed is reprojected into a sphere to enable simulated camera movements without physical tracking hardware. The region of interest selection would create the appearance of camera movements following the transformer as it moves and interacts with the concert venue space, including potential interactions with stage elements and venue architecture.

Simultaneously, FIG. 5's compositing operations would be performed, where the pre-rendered transformer animation with alpha channel is precisely synchronized with the camera tracking data to maintain proper positioning relative to the stage and venue structures. The compositing algorithms would ensure seamless integration of the high-quality transformer visual effects with the live video feed while maintaining proper perspective throughout the simulated camera movements.

The final composited output showing the transformer interacting with the concert venue would be converted to broadcast standard resolution and distributed through either traditional broadcast or network-based protocols. The entire sequence would be triggered through the Show Control interface without requiring live camera local operators or directors.

### Example Mobile Device

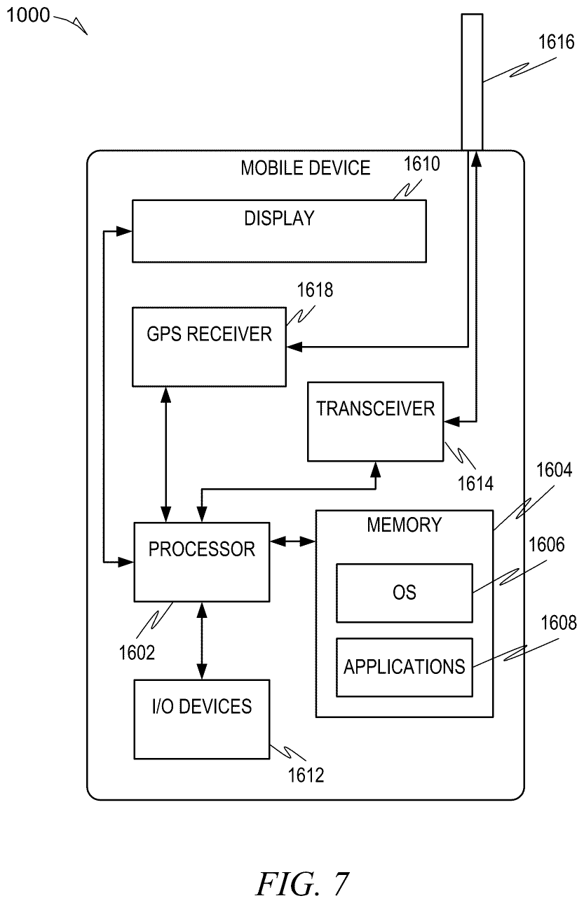

FIG. 7 is a block diagram illustrating a mobile device 1000, according to an example embodiment. The mobile device 1000 can include a processor 1602. The processor 1602 can be any of a variety of different types of commercially available processors suitable for mobile devices 1000 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 1000. Further, in some configurations, a GPS receiver 1618 can also make use of the antenna 1616 to receive GPS signals.

In example embodiments, mobile devices may be integrated into the system in various ways. For example, mobile phones with high-resolution camera capabilities may serve as alternative video sources for the system (e.g., leveraging advanced cellular networks and APIs (e.g., Verizon's QoD system) to enable high-resolution video streaming from these devices. This integration may allow for more flexible deployment options, particularly in locations where fixed camera installation is impractical. The mobile device's GPS receiver may provide precise location data that can be incorporated into the system's spatial reference calculations, enhancing the accuracy of camera positioning and virtual element placement. Additionally, mobile devices may function as remote control interfaces for the Show Control module, allowing operators to trigger mixed reality sequences, adjust camera movements, or monitor outputs from anywhere within the venue through dedicated applications running on the device. The mobile device's processing capabilities could also be utilized for preliminary image analysis or calibration tasks before transmitting the high-resolution video feed to the main system, potentially reducing bandwidth requirements while maintaining visual quality. As network infrastructure evolves to support higher bandwidth signals, these mobile integrations may enable new applications of the technology using mobile phone cameras as primary video sources for mixed reality productions.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In various example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

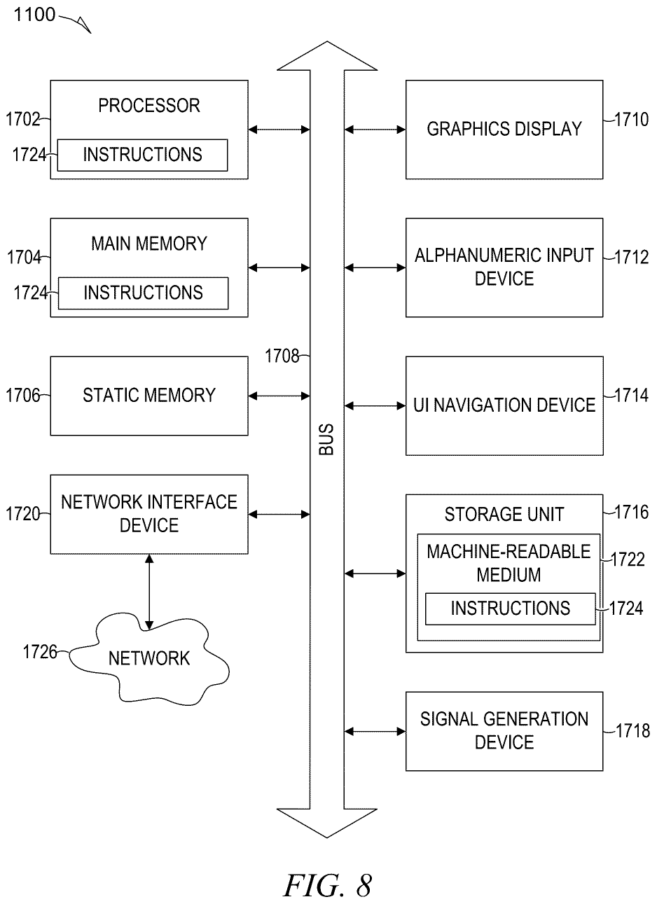

FIG. 8 is a block diagram of an example computer system 1100 on which methodologies and operations described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1702 (e.g., a central processing unit (CPU), a graphics processing unit (GPU) or both), a main memory 1704 and a static memory 1706, which communicate with each other via a bus 1708. The computer system 1100 may further include a graphics display unit 1710 (e.g., a liquid crystal display (LCD) or a cathode ray tube (CRT)). The computer system 1100 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 on which is stored one or more sets of instructions and data structures (e.g., software) 1724 embodying or utilized by any one or more of the methodologies, operations, or functions described herein. The instructions 1724 may also reside, completely or at least partially, within the main memory 1704 and/or within the processor 1702 during execution thereof by the computer system 1100, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

In example embodiments, the computer system 1100 illustrated in FIG. 8 serves as the computational foundation for the mixed reality video production and compositing system in various deployment scenarios. For on-premise venue deployments, the computer system 1100 may be configured as a specialized media server with multiple video I/O cards specifically designed for consuming high-resolution signals (e.g., up to four 8K signals per server). The processor 1702 may be optimized for real-time video processing tasks, including lens distortion calculations, spherical reprojection operations, and region of interest selections that enable simulated camera movements. The main memory 1704 and static memory 1706 may be configured with sufficient capacity to handle the substantial data requirements of high-resolution video processing, while the storage unit 1716 may store pre-rendered content, calibration data, and venue-specific configuration files.

In example embodiments, the network interface device 1720 enables the system to transmit processed video signals through venue infrastructure (e.g., supporting both traditional broadcast video standards and network-based signal protocols). In rack-mounted configurations, multiple computer systems may be interconnected (e.g., through a combination of 12G video cables, fiber optic infrastructure, and standard broadcast signal routing equipment) to create a comprehensive mixed reality production system. The graphics display unit 1710 may be utilized for monitoring outputs and providing operator interfaces for calibration processes, where users can select known points of reference while viewing the image source from the camera.

For cloud-based deployments, the computer system 1100 architecture may be virtualized across distributed computing resources, with only cameras and basic signal conversion equipment remaining on-premise. The network interface device 1720 may leverage advanced network APIs to enable high-resolution video streaming to cloud processing systems. The processor 1702 and memory components (1704, 1706) may be distributed across multiple virtual machines optimized for different aspects of the processing pipeline, such as calibration calculations, video processing, and compositing operations.

In both deployment scenarios, the machine-readable medium 1722 contains instructions 1724 that, when executed, implement the various methodologies described in FIGS. 3-6, including camera calibration, region of interest selection, video compositing, and show control functionality. The UI navigation device 1714 and alphanumeric input device 1712 provide interfaces for operators to control the system, including triggering pre-programmed mixed reality sequences through the Show Control module. The signal generation device 1718 may be configured to output the final composited video signal in formats compatible with broadcast standards.

As network infrastructure evolves to support higher bandwidth signals, the computer system 1100 may be increasingly deployed in remote production environments without requiring all media server equipment to be on-site, enabling more flexible and scalable implementations of the mixed reality production system. This evolution toward cloud-based processing may leverage the communications network 1726 to transmit high-resolution video signals while maintaining the low-latency processing necessary for proper synchronization between virtual and physical elements.

In example embodiments, the optical calibration process interfaces with the computer system of FIG. 8 through specialized computational workflows designed for fixed-position cameras. The calibration process begins with the capture of calibration images using fixed-position high-resolution cameras that are approximately the size of industrial security cameras, which can be pre-installed with minimal disruption to venue operations. These fixed cameras, equipped with fixed focal length lenses, may serve as the foundation of the system's ability to simulate camera movements without mechanical tracking hardware.

The computer system 1100 of FIG. 8 may serve as the primary computational engine for the optical calibration process, with the processor 1702 executing specialized algorithms that analyze the calibration images to mathematically solve for lens distortion characteristics. The graphics display unit 1710 provides an interface where users can select known points of reference while viewing the image source from the fixed camera, enabling the system to automatically calculate camera position and rotation relative to real-world coordinates. The main memory 1704 and static memory 1706 may store the comprehensive lens profiles generated through the calibration process, while the storage unit 1716 may maintain venue-specific calibration data that only needs to be created once for fixed focal length lenses, unlike traditional systems requiring frequent recalibration for zoom lenses.

The UI navigation device 1714 and alphanumeric input device 1712 may allow for precise selection of reference points during the calibration process, particularly when zooming in for accurate alignment between visual reference points and their corresponding spatial coordinates. The network interface device 1720 enables calibration data to be shared between on-premise equipment and potentially cloud-based processing resources when deployed in distributed computing environments, allowing the optical calibration process to be performed with the precision necessary for accurate spherical reprojection and region of interest operations that form the core of the system's camera movement simulation capabilities.

The mobile device illustrated in FIG. 7 can serve as an alternative video source in certain scenarios. In example embodiments, the mobile device 1000 can be integrated with the mixed reality video production system by leveraging its high-resolution camera capabilities to capture video feeds that could then be processed through the same spherical projection and region of interest workflows. The mobile device's processor 1602 can perform preliminary image processing before transmitting the video signal to the main system, potentially reducing bandwidth requirements while maintaining visual quality.

The transceiver 1614 can interface with advanced cellular networks and APIs (e.g., Verizon's QoD system) to enable high-resolution video streaming from the mobile device to the media server infrastructure. This integration could be particularly valuable in locations where fixed camera installation is impractical or for capturing supplementary angles in a multi-camera production. The mobile device's GPS receiver 1618 could provide precise location data that could be incorporated into the spatial reference calculations, enhancing the accuracy of camera positioning and virtual element placement within the mixed reality environment.

Additionally, the mobile device could function as a remote control interface for the Show Control module, with the display 1610 and I/O devices 1612 enabling operators to trigger mixed reality sequences, adjust camera movements, or monitor outputs from anywhere within the venue through dedicated applications 1608 running on the device. As network infrastructure evolves to support higher bandwidth signals, these mobile integrations may enable new applications of the technology using mobile phone cameras as primary or supplementary video sources for mixed reality productions.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system comprising:
one or more computer processors;
one or more computer memories;
a set of instructions stored in the one or more computer memories, the set of instructions configuring the one or more computer processors to perform operations, the operations comprising:
receiving one or more high-resolution video feeds from one or more fixed-position cameras;
transforming each of the one or more high-resolution video feeds into respective spherical projections based on respective lens distortion profiles and spatial reference data;
selecting one or more regions of interest within the respective spherical projections;
simulating one or more movements of the one or more fixed-position cameras within the selected one or more regions of interest; and
generating an output video that includes one of the one or more the regions of interest, the output video conforming to one or more broadcast resolution requirements.

2. The system of claim 1, the operations further comprising:
capturing a plurality of calibration images using the one or more fixed-position cameras and corresponding lenses;
determining lens distortion characteristics based on an analysis of the plurality of calibration images; and
generating the respective lens distortion profiles based on the determined lens distortion characteristics.

3. The system of claim 2, the operations further comprising:
receiving selections of known points made in a user interface during the capturing of the plurality of calibration images using the one or more fixed-position cameras;
correlating the selections of known points with the spatial reference data to establish real-world coordinates; and
automatically calculating position and rotation coordinates for the one or more fixed-position cameras based on the correlated selections of known points.

4. The system of claim 3, wherein the transforming of each of the one or more high-resolution video feeds into respective spherical projections comprises:
applying the respective lens distortion profiles to correct optical aberrations in each of the one or more high-resolution video feeds; and
reprojecting the one or more corrected high-resolution video feeds into the respective spherical projections based on the calculated position and rotation coordinates.

5. The system of claim 1, wherein the spatial reference data comprises one or more of Total Station Point Reference measurements, Known Field Dimensions, or 3D Lidar scan data.

6. The system of claim 1, wherein the selecting of the one or more regions of interest is based on maintaining proper perspective and spatial relationships throughout the simulating of the one or more movements.

7. The system of claim 3, wherein the simulating of the one or more movements of the one or more fixed-position cameras comprises:
processing camera tracking data to establish field of view and rotation parameters for the one or more movements;
synchronizing the camera tracking data with the selected one or more regions of interest to maintain proper spatial relationships throughout the one or more movements;
creating an appearance of traditional camera operations through computational processing of the selected one or more regions of interest within the respective spherical projections; and
maintaining proper perspective and spatial accuracy throughout the one or more movements based on the calculated position and rotation coordinates.

8. The system of claim 7, the operations further comprising:
receiving rendered content;
synchronizing the rendered content with the camera tracking data to maintain proper positioning and orientation of one or more virtual elements included in the rendered content relative to physical space; and
performing one or more overlay operations to composite the rendered content onto the one or more high-resolution video feeds.

9. A method comprising:
receiving one or more high-resolution video feeds from one or more fixed-position cameras;
transforming each of the one or more high-resolution video feeds into respective spherical projections based on respective lens distortion profiles and spatial reference data;
selecting one or more regions of interest within the respective spherical projections;
simulating one or more movements of the one or more fixed-position cameras within the selected one or more regions of interest; and
generating an output video that includes one of the one or more the regions of interest, the output video conforming to one or more broadcast resolution requirements.

10. The method of claim 9, further comprising:
capturing a plurality of calibration images using the one or more fixed-position cameras and corresponding lenses;
determining lens distortion characteristics based on an analysis of the plurality of calibration images; and
generating the respective lens distortion profiles based on the determined lens distortion characteristics.

11. The method of claim 10, further comprising:
receiving selections of known points made in a user interface during the capturing of the plurality of calibration images using the one or more fixed-position cameras;
correlating the selections of known points with the spatial reference data to establish real-world coordinates; and
automatically calculating position and rotation coordinates for the one or more fixed-position cameras based on the correlated selections of known points.

12. The method of claim 11, wherein the transforming of each of the one or more high-resolution video feeds into respective spherical projections comprises:
applying the respective lens distortion profiles to correct optical aberrations in each of the one or more high-resolution video feeds; and
reprojecting the one or more corrected high-resolution video feeds into the respective spherical projections based on the calculated position and rotation coordinates.

13. The method of claim 9, wherein the spatial reference data comprises one or more of Total Station Point Reference measurements, Known Field Dimensions, or 3D Lidar scan data.

14. The method of claim 11, wherein the simulating of the one or more movements of the one or more fixed-position cameras comprises:
processing camera tracking data to establish field of view and rotation parameters for the one or more movements;
synchronizing the camera tracking data with the selected one or more regions of interest to maintain proper spatial relationships throughout the one or more movements;
creating an appearance of traditional camera operations through computational processing of the selected one or more regions of interest within the respective spherical projections; and
maintaining proper perspective and spatial accuracy throughout the one or more movements based on the calculated position and rotation coordinates.

15. The method of claim 14, further comprising:
receiving rendered content;
synchronizing the rendered content with the camera tracking data to maintain proper positioning and orientation of one or more virtual elements included in the rendered content relative to physical space; and
performing one or more overlay operations to composite the rendered content onto the one or more high-resolution video feeds.

16. A non-transitory computer-readable storage medium storing a set of instructions that, when executed by one or more computer processors, causes the one or more computer processors to perform operations, the operations comprising:
receiving one or more high-resolution video feeds from one or more fixed-position cameras;
transforming each of the one or more high-resolution video feeds into respective spherical projections based on respective lens distortion profiles and spatial reference data;
selecting one or more regions of interest within the respective spherical projections;
simulating one or more movements of the one or more fixed-position cameras within the selected one or more regions of interest; and
generating an output video that includes one of the one or more the regions of interest, the output video conforming to one or more broadcast resolution requirements.

17. The non-transitory computer-readable storage medium of claim 16, the operations further comprising:
capturing a plurality of calibration images using the one or more fixed-position cameras and corresponding lenses;
determining lens distortion characteristics based on an analysis of the plurality of calibration images; and
generating the respective lens distortion profiles based on the determined lens distortion characteristics.

18. The non-transitory computer-readable storage medium of claim 17, the operations further comprising:
receiving selections of known points made in a user interface during the capturing of the plurality of calibration images using the one or more fixed-position cameras;
correlating the selections of known points with the spatial reference data to establish real-world coordinates; and
automatically calculating position and rotation coordinates for the one or more fixed-position cameras based on the correlated selections of known points.

19. The non-transitory computer-readable storage medium of claim 18, wherein the simulating of the one or more movements of the one or more fixed-position cameras comprises:
processing camera tracking data to establish field of view and rotation parameters for the one or more movements;
synchronizing the camera tracking data with the selected one or more regions of interest to maintain proper spatial relationships throughout the one or more movements;
creating an appearance of traditional camera operations through computational processing of the selected one or more regions of interest within the respective spherical projections; and
maintaining proper perspective and spatial accuracy throughout the one or more movements based on the calculated position and rotation coordinates.

20. The non-transitory computer-readable storage medium of claim 19, the operations further comprising:
receiving rendered content;
synchronizing the rendered content with the camera tracking data to maintain proper positioning and orientation of one or more virtual elements included in the rendered content relative to physical space; and
performing one or more overlay operations to composite the rendered content onto the one or more high-resolution video feeds.
